(19) United States
(12) Patent Application Publication
(10) Pub. No.: US 2004/0070965 A1
(43) Pub. Date: Apr. 15, 2004

(54) Removable light guide system for advertising display

(76) Inventor: Bin-Tzer Lin, Taipei (TW)

Correspondence Address: J. Warren Whitesel, Michael Best & Friedrich LLC, 401 N. Michigan Avenue, Suite 1900, Chicago, IL, 60611, US

(21) Appl. No.: 10/268,460

(22) Filed: Oct. 10, 2002

(51) Int. Cl. F21V 8/00; F21V 19/00; F21S 4/00

(52) U.S. Cl. 362/31; 362/225; 362/223

(57) ABSTRACT

A light guide system including a light guide board assembly and a removable lighting module for providing display light to posters, display articles, or signs is disclosed. The light guide board assembly comprises pre-laminated opaque layer as reflector, semi-transparent layer as diffuser, and a layer of acrylic adhesive as intermediate for better light guide and brighter illumination. The removable lighting module includes control unit and light source unit that can be disposed flexibly on different sizes of light guide board assembly for system illumination.

### FIELD OF THE INVENTION

The present invention relates generally to an advertising display, and more particularly to a removable light guide system for advertising display.

### BACKGROUND OF THE INVENTION

There are two kinds of commercially available methods to provide light source for advertising display. One is by using independent light devices like spot light bulbs; and the other is by using neon light boxes. Generally, independent light devices like spot light bulbs are disposed on the wall and adjacent to the advertising display for illuminating the display article. Such a lighting system is lacking of flexibility and poor in brightness. In addition, the neon light boxes used in commercial advertising are large and heavy. The neon light box employs plural fluorescent light tubes as the light source, which requires tremendous electricity consumption. The brightness may not be uniform due to poor arrangement of the fluorescent light tubes. It is also difficult to change the advertising board disposed above the light source without destroying the neon light box, which will cause a waste of material and money. Therefore, both of the conventional methods are lacking of flexibility, high cost due to engineering installation needs, and more space and power consuming.

U.S. Pat. No. 5,676,444 to Liao shows a slim light box incorporating a light tube, a light guide with grooves and diffuser, for illuminating display article. The invention improved the space and power consumption problem to some degree, but still it does not provide solution to the need of higher brightness and more flexibility at lower cost.

It is therefore urged to provide a removable light guide system for providing display light to posters, display articles or signs, which can be flexibly assembled for instant illumination needs and have better brightness at lower cost.

### SUMMARY OF THE INVENTION

One object of the present invention is to provide a new and improved lighting guide system for advertising display.

Another object of the present invention is to provide a lighting system having high flexibility that can be easily adaptable to many different applications.

Yet another object of the present invention is to provide a lighting system having high brightness.

A further object of the present invention is to provide a lighting system which is compact in size.

To achieve the above-mentioned objects, a removable light guide system is provided. The removable light guide system includes a light guide board assembly; and a lighting module removably disposed on one side edge of the light guide board assembly for providing light and illuminating the light guide board assembly.

In accordance with one aspect of the present invention, the light guide board assembly includes a transparent board made of glass or acrylic having its one side laminated with a reflector and the other side laminated with a diffuser.

In accordance with another aspect of the present invention, the reflector comprises a first layer made of glossy opaque film, paper, or fabric and coated with a second layer made of acrylic based adhesive as intermediate between the first layer and the transparent board.

In accordance with another aspect of the present invention, the diffuser comprises a third layer made of semi-transparent film, paper, or fabric and coated with a fourth layer made of acrylic based adhesive as intermediate between the third layer and the transparent board.

In accordance with another aspect of the present invention, the reflector and the diffuser are laminated fully or partially on the transparent board.

In accordance with another aspect of the present invention, the lighting module includes a main housing, a control unit, and a light source unit.

In accordance with another aspect of the present invention, the main housing has an internal space and at least one opening formed on the end thereof, whereby the control unit and the light source unit are accommodated within the main housing.

In accordance with another aspect of the present invention, the main housing further includes at least one side cover for covering the opening.

In accordance with another aspect of the present invention, the main housing is a molded housing with pre-determined stands therein for accommodations of the control and light source units and connecting slot for insertion of the light guide board assembly.

In accordance with another aspect of the present invention, the main housing further includes a plurality of upper panels disposed in the internal space of the main housing to form one of the stands for accommodation of the control unit; a plurality of lower panels disposed in the internal space of the main housing to form another of the stands for accommodation of the light source unit; and two guide rails disposed in the internal space of the main housing to define a connecting slot for enabling the light guide board assembly to be inserted and positioned therebetween.

In accordance with another aspect of the present invention, the upper panels are parallel to each other and extending along the axial direction of the main housing, the lower panels are parallel to each other and extending along the axial direction of the main housing, and the guide rails are parallel to each other and extending inwardly from the peripheral edge of the opening.

In accordance with another aspect of the present invention, the main housing further includes a power connection hole, a switch hole, and at least one adjustment hole.

In accordance with another aspect of the present invention, the main housing further includes at least one adjustable device mounted through the adjustment hole for securing the light module with the light guide board assembly, thereby different thickness of the light guide board assembly can be inserted into the lighting module.

Preferably, the main housing is in the shape of cylinder with its diameter in range of 5-50 mm.

Preferably, the main housing is in the shape of square, oval, or rectangle with its cross-sectional length and width in range of 5-50 mm.

In accordance with another aspect of the present invention, the control unit includes a base board in pre-determined width to fit with the main housing on which at least one electronic element is mounted for providing control of the system, and a plurality of bendable fasteners to secure the control unit to the main housing while the control unit is inserted and positioned in the main housing.

In accordance with another aspect of the present invention, the light source unit includes a base board in pre-determined width to fit with the main housing and with a pre-determined slot in the center for installation of at least one light element, a reflective film covering on the top of the light element, and a plurality of bendable fasteners to secure the light source unit to the main housing while the light source is inserted and positioned in the main housing.

To achieve the above-mentioned objects, a light guide board assembly is also provided. The light guide board assembly includes a transparent board made of glass or acrylic and having its one side laminated with a reflector and the other side laminated with a diffuser. Preferably, the reflector comprises a first layer made of glossy opaque film, paper, or fabric and coated with a second layer made of acrylic based adhesive as intermediate between the first layer and the transparent board. More preferably, the diffuser comprises a third layer made of semi-transparent film, paper, or fabric and coated with a fourth layer made of acrylic based adhesive as intermediate between the third layer and the transparent board.

To achieve the above-mentioned objects, a lighting module, adapted to be disposed on one side of a light guide board assembly, is still provided. The lighting module includes a control unit; a light source unit; and a main housing being a molded housing with its cross-sectional length and width in range of 5-50 mm. The main housing has pre-determined stands therein for accommodations of the control and light source units and a connecting slot for insertion of the light guide board assembly.

To achieve the above-mentioned objects, a removable light guide system is further provided. The removable light guide system includes a light guide board assembly; and a plurality of lighting modules, each of which is removably disposed on one side edge of the light guide board assembly for providing light and illuminating the light guide board assembly.

Now the foregoing and other features and advantages of the present invention will be best understood through the following descriptions with reference to the accompanying drawings, wherein:

### BRIEF DESCRIPTION OF THE DRAWINGS

FIG. 1 is a structural view of the light guide system according to a preferred embodiment of the present invention;

FIG. 2 is an exploded perspective view of the lighting module of FIG. 1;

FIG. 3 is a perspective view of the main housing of FIG. 2;

FIG. 4 is a structural view of the side cover;

FIG. 5 is a side view of the main housing of FIG. 3;

FIG. 6 is a structural view of the control unit of FIG. 2;

FIG. 7 is a top view of the light source unit of FIG. 2;

FIG. 8 is a cross sectional view of the light source unit of FIG. 7;

FIG. 9 is an exploded perspective view of light guide board assembly of FIG. 2;

FIG. 10 is a side view showing the light guide board assembly of FIG. 9 after lamination;

FIG. 11 is a perspective view of singe-use application according to the preferred embodiment of the present invention; and

FIG. 12 is perspective view of multi-use application according to another preferred embodiment of the present invention.

### DETAILED DESCRIPTION OF THE PREFERRED EMBODIMENT

The present invention is made by the provision of a removable light guide system for illuminating display article, which can be flexibly assembled for instant illumination needs and have better and uniform brightness at lower cost. A preferred embodiment incorporating the features and advantages of the present invention will be enumerated in following paragraphs of descriptions. It is to be realized that the present invention is allowed to have various modification in different respects, all of which are without departing from the scope of the present invention, and the description herein and the drawings are intended to be taken as illustrative in nature, and are not limitative.

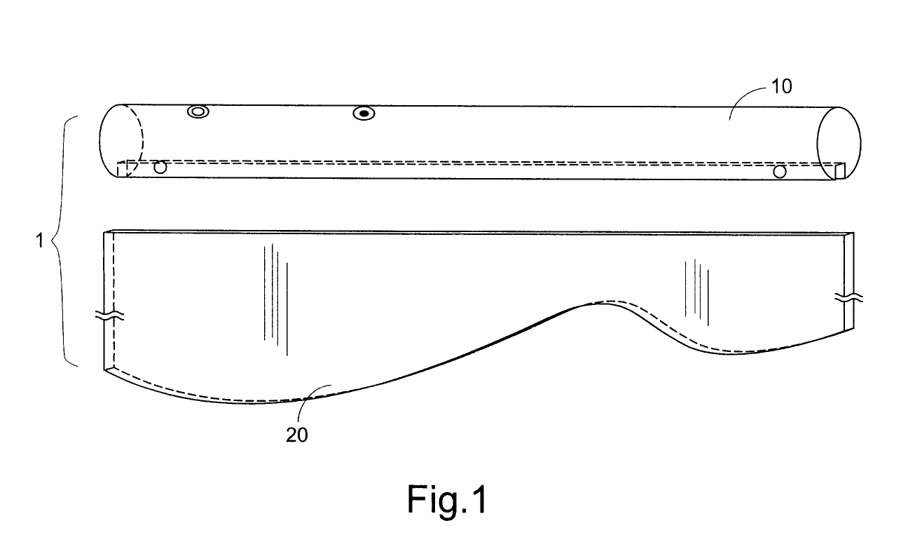

Please refer to FIG. 1, which is the structural view showing the light guide system for advertising display according to a preferred embodiment of the present invention. As shown in FIG. 1, the removable light guide system 1 includes a lighting module 10 and a light guide board assembly 20. The lighting module 10 can be disposed on one side edge of the light guide board assembly 20 flexibly for illuminating the light guide board assembly and providing display light to posters, display articles or signs.

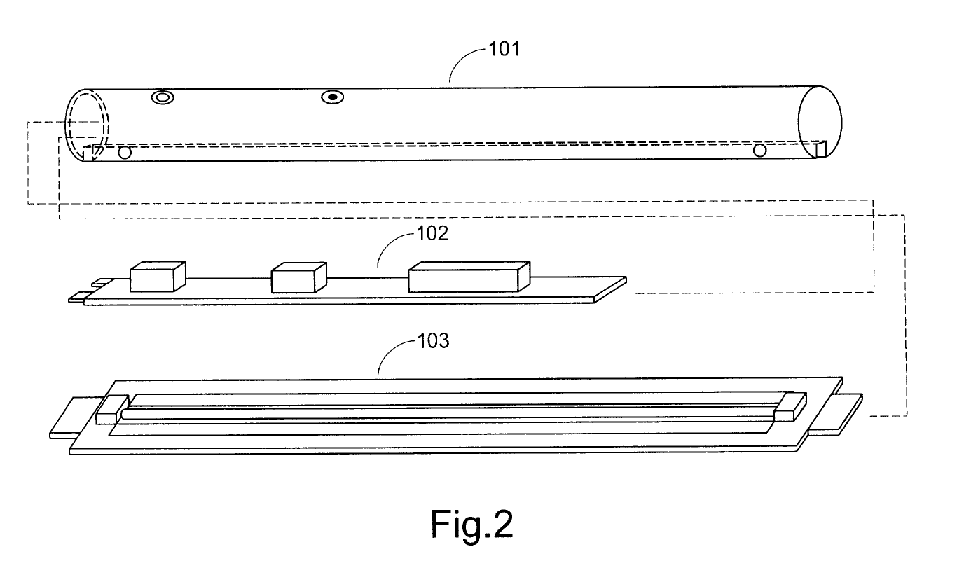

Referring to FIG. 2, which is an exploded perspective view showing the lighting module 10 of FIG. 1. The lighting module 10 includes a main housing 101, a control unit 102, and a light source unit 103. The main housing 101 has an internal space and at least one opening formed on the end thereof so that the control unit 102 and light source unit 103 are accommodated within the main housing 101.

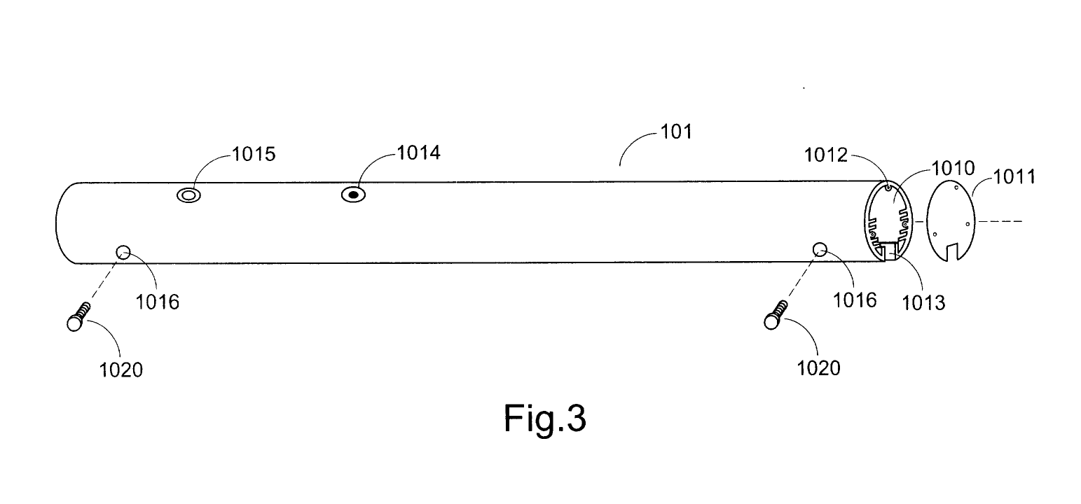

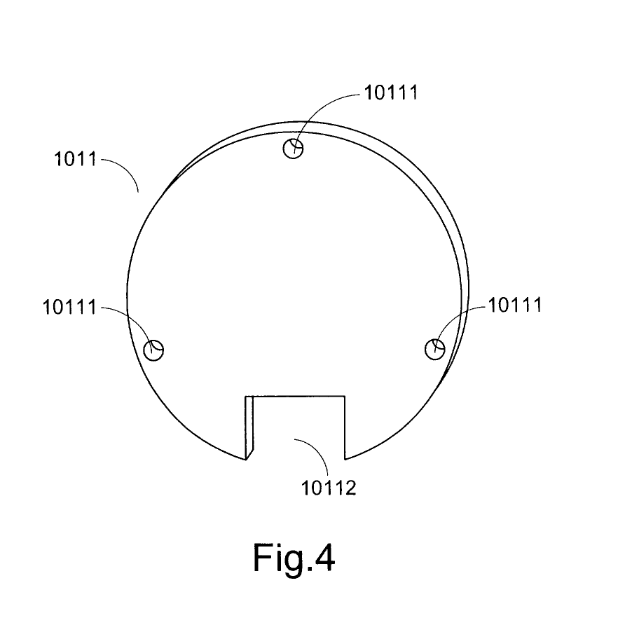

Please refer to FIG. 3, which is a perspective view showing the main housing 101 of FIG. 2. As shown in FIG. 3, the main housing 101 has one opening 1010 formed on one end thereof. Certainly, the main housing 101 can also be designed to have two openings formed on both ends thereof. The opening 1010 can be covered by a side cover 1011. As shown in FIG. 4, the side cover 1011 of the main housing 101 has fixture holes 10111 corresponding to the holes 1012 of the main housing 101 so that the side cover 1011 can be secured to the main housing 101 and cover the opening 1010 of the main housing 101 by screwing (not shown). A slot 10112 is also formed on the edge of the side cover 1011 and corresponding to the connecting slot 1013 of the main housing 101. It functions with the adjustable device 1020 and provides possibility of insertion of different thickness light guide board assembly 20.

Please refer to FIG. 3 again. The main housing 101 further includes a power connection hole 1014 for installation of DC power base, a switch hole 1015 for power switch placement, and adjustment holes 1016 for adjustment and fixture of the inserted light guide board assembly 20. The main housing 101 is compact to minimize space requirement. The diameter of the main housing 101 is in range of 5-50 mm in case of a cylindrical design, or cross-sectional length and width are in the same range of 5-50 mm in case of a square, oval, or rectangle design.

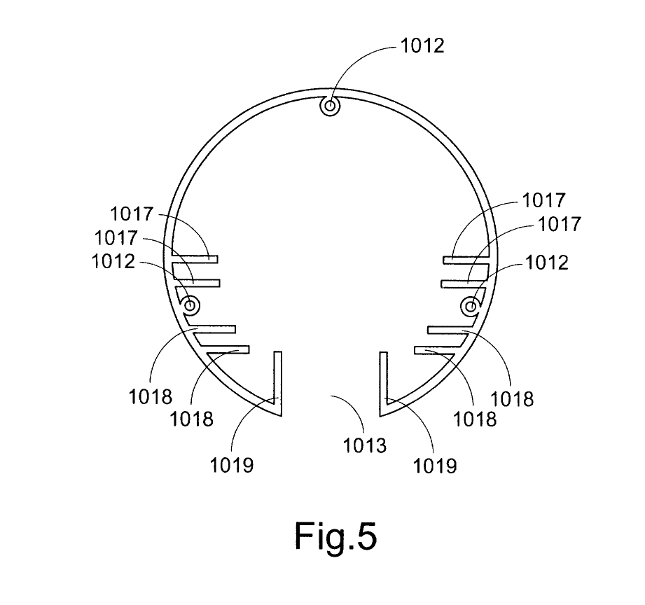

Referring to FIG. 5, which is the side view of the main housing 101 of FIG. 3. The main housing 101 is an extruded or molded cylindrical device including fixture holes 1012 formed on the peripheral edge of the opening 1010. In the internal space of the main housing 101, a plurality of upper panels 1017 are employed to form a stand for accommodation of control unit 102. The upper panels 1017 are parallel to each other and extending along the axial direction of the main housing 101. Beside the upper panels 1017, the main housing 101 also employs a plurality of lower panels 1018 to form a stand for light source unit 103 placement. Similarly, the lower panels 1018 are parallel to each other and extending along the axial direction of the main housing 101. Two guide rails 1019 are disposed in the internal space of the main housing 101 and define the connecting slot 1013 for enabling the light guide board assembly 20 to be inserted and positioned therebetween. The guide rails 1019 are parallel to each other and extending inwardly from the peripheral edge of the opening 1010.

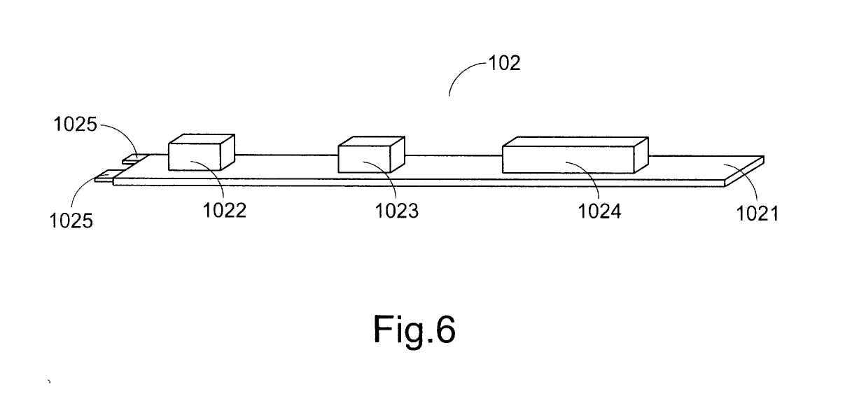

Please refer to FIG. 6, which is the structural view of the control unit of FIG. 2. As shown in FIG. 6, the control unit 102 has a base board 1021 in pre-determined width to fit with the main housing 101 on which switch device 1022, power connection stand 1023, and IC control elements 1024 are mounted. Bendable fasteners 1025 are provided on one side of the base board 1021. Bendable fasteners 1025 can be bended and connected to the upper panels 1017 of the main housing 101 to secure the control unit 102 within the main housing 101. When the control unit 102 is inserted into the main housing 101 from the opening 1010 and secured in the main housing 101, the power connection hole 1014 and switch hole 1015 are respectively corresponding to the power connection stand 1023 and the switch device 1022 for installation of DC power base and power switch placement.

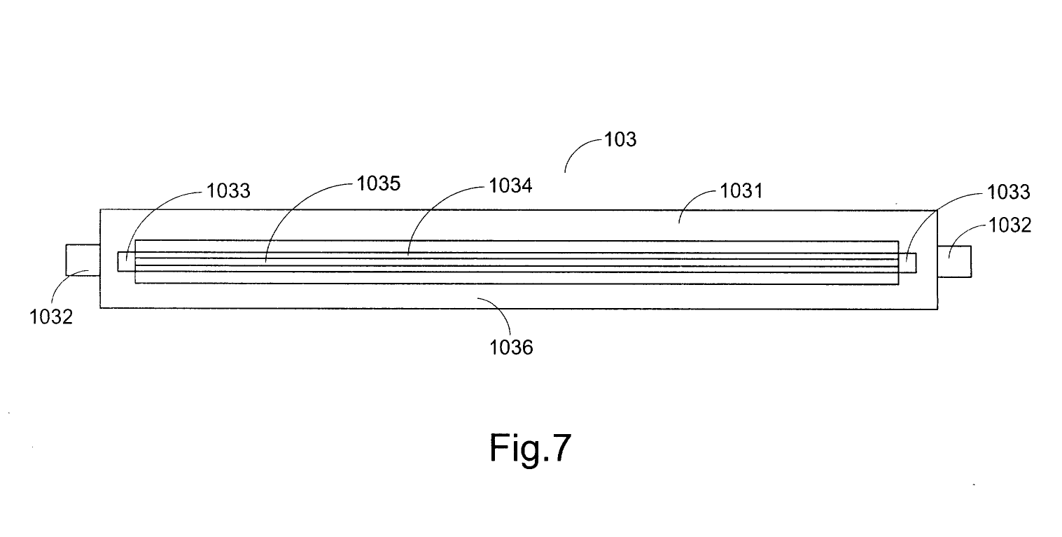

Referring to FIG. 7, which is the top view of the light source unit of FIG. 2. As shown in FIG. 7, the light source unit 103 has a base board 1031 in pre-determined width to fit with the main housing and with pre-determined slot 1034 in the center. A light source 1035 composed of light tube or LED is positioned in a linear array in the center of slot 1034 and secured by stand 1033 on both sides. Bendable fasteners 1032 are provided on both sides of the base board 1031 and can be bended and connected to the lower panels 1018 of main housing 101 to secure the light source unit 103 therein when the light source unit 103 is inserted in the main housing 101 from the opening 1010.

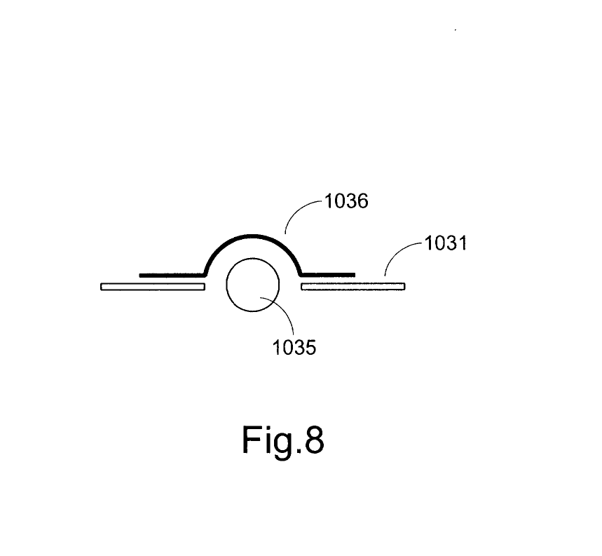

Referring to FIG. 8, a reflective film 1036 is covered over the top of the light source 1035 so that the light can be reflected and directed into light guide board assembly 20, thereby increasing the brightness.

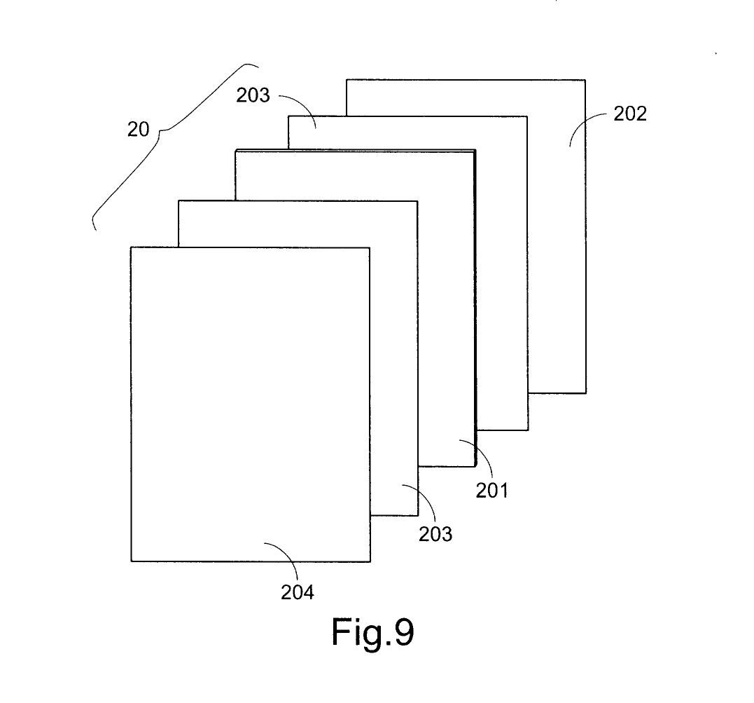

Please refer to FIG. 9, which is the exploded perspective view of light guide board assembly of FIG. 2. As shown in FIG. 9, the light guide board assembly 20 includes a transparent board 201 made of glass or acrylic, a reflector comprising a first layer made of glossy opaque film, paper, or fabric and coated with a second layer made of acrylic based adhesive as intermediate between the first layer and the transparent board, and a diffuser comprising a third layer made of semi-transparent film, paper, or fabric and coated with a fourth layer made of acrylic based adhesive as intermediate between the third layer and the transparent board. The reflector and the diffuser can be laminated fully or partially on the transparent board 201 so that the display design can be illuminated fully or partially as desired.

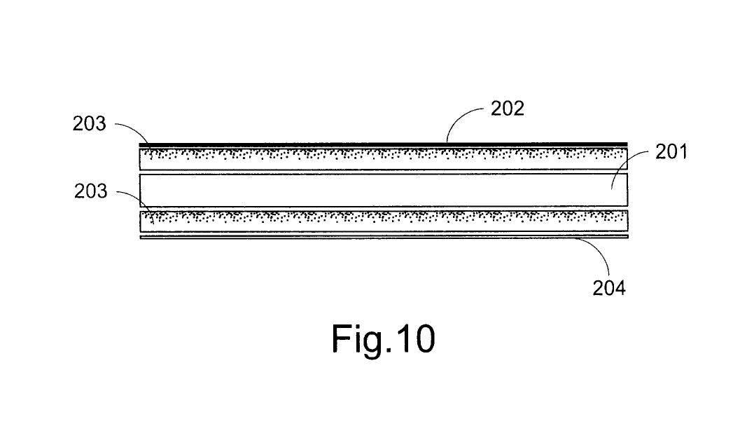

Referring to FIG. 10, the light guide board assembly 20 comprises pre-laminated layer 202 made of glossy opaque film, paper or fabric, layer 204 made of semi-transparent film, paper, or fabric, and intermediate acrylic adhesive layers 203. Each of the acrylic adhesive layers is disposed as an intermediate on which light beams are freely transmitted and makes better brightness of the system.

The connecting slot 1013 of the lighting module 10 can receive one side edge of the light guide board assembly 20. When the side edge of the light guide board assembly 20 is inserted into the connecting slot 1013 of the lighting module 10, a plurality of adjustable devices 1020 are employed to bias against the side edge of the light guide board assembly 20 to provide possibility of insertion of different thickness light guide board assembly 20.

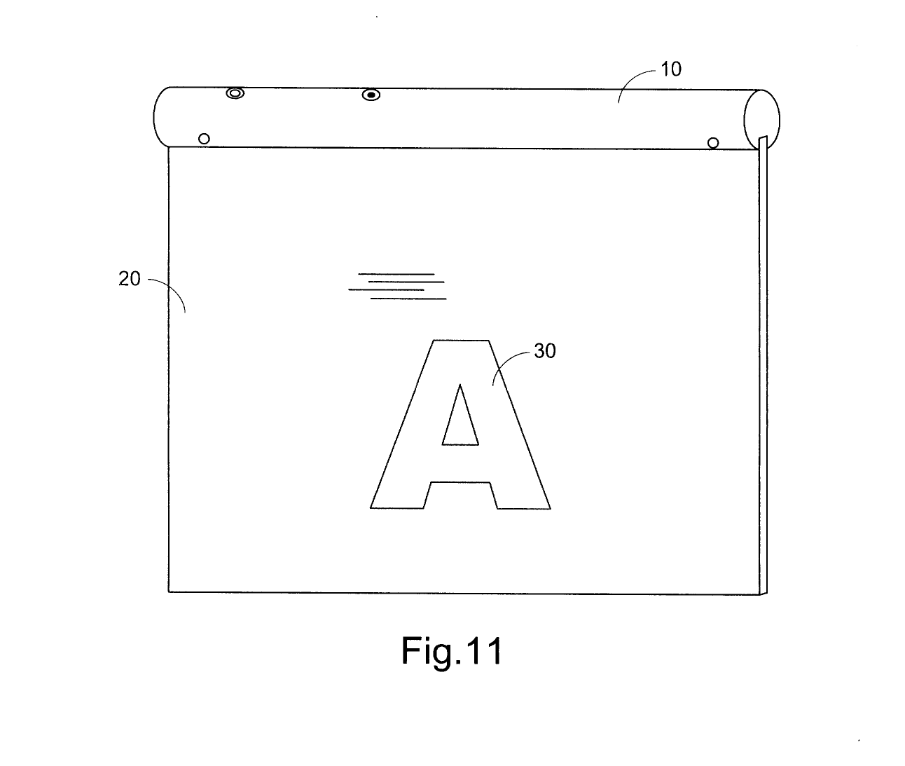

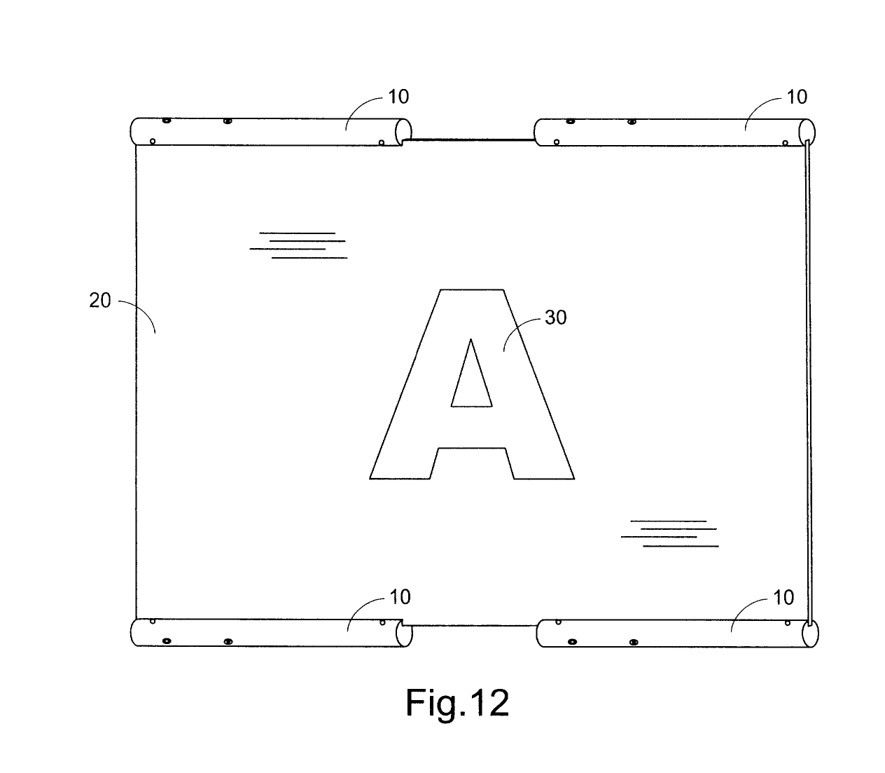

Referring to FIG. 11, which shows a single removable lighting module 10 performing with a light guide board assembly 20 for illuminating display article 30. It is very easy to assemble and disassemble the removable light module 10 and the light guide board assembly 20. In addition, the display article 30 can fully or partially disposed on the semi-transparent film 204 of the light guide board assembly 20. Certainly, multiple removable lighting modules 10 functioning flexibly with a larger light guide board assembly 20 can also be designed for illuminating display article 30, as shown in FIG. 12.

In contrast to the conventional lighting system for advertising display, the present invention utilizes separated lighting module 10 and light guide board assembly 20 by which can be flexibly assembled for instant illumination needs. In addition to the flexibility, the light guide board assembly utilized lamination process to form a reflector and diffuser layers so that a better brightness can be obtained at lower cost.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A removable light guide system, comprising:
a light guide board assembly; and
a lighting module removably disposed on one side edge of said light guide board assembly for providing light and illuminating said light guide board assembly.

2. The removable light guide system according to claim 1 wherein said light guide board assembly comprises a transparent board made of glass or acrylic having its one side laminated with a reflector and the other side laminated with a diffuser.

3. The removable light guide system according to claim 2 wherein said reflector comprises a first layer made of glossy opaque film, paper, or fabric and coated with a second layer made of acrylic based adhesive as intermediate between said first layer and said transparent board.

4. The removable light guide system according to claim 2 wherein said diffuser comprises a third layer made of semi-transparent film, paper, or fabric and coated with a fourth layer made of acrylic based adhesive as intermediate between said third layer and said transparent board.

5. The removable light guide system according to claim 2 wherein said reflector and said diffuser are laminated fully or partially on said transparent board.

6. The removable light guide system according to claim 1 wherein said lighting module comprises a main housing, a control unit, and a light source unit.

7. The removable light guide system according to claim 6 wherein said main housing has an internal space and at least one opening formed on the end thereof, whereby said control unit and said light source unit are accommodated within said main housing.

8. The removable light guide system according to claim 7 wherein said main housing further comprises at least one side cover for covering said opening.

9. The removable light guide system according to claim 7 wherein said main housing is an molded housing with pre-determined stands therein for accommodations of said control and light source units and connecting slot for insertion of said light guide board assembly.

10. The removable light guide system according to claim 9 wherein said main housing further comprises:
a plurality of upper panels disposed in said internal space of said main housing to form one of said stands for accommodation of said control unit;
a plurality of lower panels disposed in said internal space of said main housing to form another of said stands for accommodation of said light source unit; and
two guide rails disposed in said internal space of said main housing to define a connecting slot for enabling said light guide board assembly to be inserted and positioned therebetween.

11. The removable light guide system according to claim 10 wherein said upper panels are parallel to each other and extending along the axial direction of said main housing, said lower panels are parallel to each other and extending along the axial direction of said main housing, and said guide rails are parallel to each other and extending inwardly from the peripheral edge of said opening.

12. The removable light guide system according to claim 6 wherein said main housing further comprises a power connection hole, a switch hole, and at least one adjustment hole.

13. The removable light guide system according to claim 12 wherein said main housing further comprises at least one adjustable device mounted through said adjustment hole for securing said light module with said light guide board assembly, thereby different thickness of said light guide board assembly can be inserted into said lighting module.

14. The removable light guide system according to claim 6 wherein said main housing is in the shape of cylinder with its diameter in range of 5-50 mm.

15. The removable light guide system according to claim 6 wherein said main housing is in the shape of square, oval, or rectangle with its cross-sectional length and width in range of 5-50 mm.

16. The removable light guide system according to claim 6 wherein said control unit includes a base board in pre-determined width to fit with said main housing on which at least one electronic element is mounted for providing control of removable light guide system, and a plurality of bendable fasteners to secure said control unit to said main housing while said control unit is inserted and positioned in said main housing.

17. The removable light guide system according to claim 6 wherein said light source unit comprises a base board in pre-determined width to fit with said main housing and with a pre-determined slot in the center for installation of at least one light element, a reflective film covering over the top of said light element, and a plurality of bendable fasteners to secure said light source unit to said main housing while said light source is inserted and positioned in said main housing.

18. A light guide board assembly, comprising:
a transparent board made of glass or acrylic and having its one side laminated with a reflector and the other side laminated with a diffuser,
wherein said reflector comprises a first layer made of glossy opaque film, paper, or fabric and coated with a second layer made of acrylic based adhesive as intermediate between said first layer and said transparent board, and said diffuser comprises a third layer made of semi-transparent film, paper, or fabric and coated with a fourth layer made of acrylic based adhesive as intermediate between said third layer and said transparent board.

19. A lighting module, adapted to be disposed on one side of a light guide board assembly, comprising:
a control unit;
a light source unit; and
a main housing being an molded housing with its cross-sectional length and width in range of 5-50 mm, said main housing having pre-determined stands therein for accommodations of said control and light source units and a connecting slot for insertion of said light guide board assembly.

20. A removable light guide system, comprising:
a light guide board assembly; and
a plurality of lighting modules, each of which is removably disposed on one side edge of said light guide board assembly for providing light and illuminating said light guide board assembly.
